(19) United States
(12) Patent Application Publication
(10) Pub. No.: US 2007/0049850 A1
(43) Pub. Date: Mar. 1, 2007

(54) Foot massage device

(76) Inventor: Yu-Tong Huang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/208,714

(22) Filed: Aug. 23, 2005

(51) Int. Cl. A61H 1/00

(52) U.S. Cl. 601/30; 601/28; 601/70; 601/90; 601/DIG. 17

(57) ABSTRACT

A foot massage device includes a motor connected to an underside of a top plate and hanged in a hole in a base. A plurality of flexible members are connected between the base and the top plate. A weight member is eccentrically connected to the output shaft of the motor so that when the output shaft rotates, the weight member rotates eccentrically to move the motor and the top plate. Due to the flexibility of the flexible members, the top plates reciprocally moves and a pad with stimulation protrusions is connected on a top of the top plate to provide massage function to the feet put on the pad.

### FIELD OF THE INVENTION

The present invention relates to a foot massage device with simple structure.

### BACKGROUND OF THE INVENTION

Foot massage is a popular way to obtain a relief both in spirit and physical body. It is approved that almost every organs of our body has a corresponding reflection area at the foot so that the foot massage is able to indirectly massage these organs without actually touching the organs. By stimulating the reflection areas, the circulation of blood of these organs can be improved and a good circulation of blood reinforces immune system to keep out body away from ill. There are many professional people providing service of foot massage. However, most of us do not have enough time to take such services and this kind of services is costly.

The present invention intends to provide a foot massage device that includes a simple structure and provides a reciprocally vibration to stimulate the users feet.

### SUMMARY OF THE INVENTION

The present invention relates to a foot massage device that includes a motor with an output shaft and the motor is fixed to an underside of a top plate which is connected to a base by a plurality of flexible members connected between the top plate and the base. The motor is hanged in a hole in the base. A weight member is eccentrically connected to the output shaft. When the motor is activated, the weight member rotates eccentrically so as to drive the motor together with the top plate. Due to the flexibility of the flexible members, the top plate moves reciprocally such that when the users feet put on the top plate, a vibration is transferred to the users feet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the foot massage device of the present invention;

FIG. 2 is an exploded view to show the foot massage device of the present invention;

FIG. 3 illustrates the eccentric movement of the weight member on the motor, and

FIG. 4 shows a user puts his/her feet on the foot massage device of the present invention.

### DETAILED DESCRIPTION OF THE PREFERRED EMBODIMENT

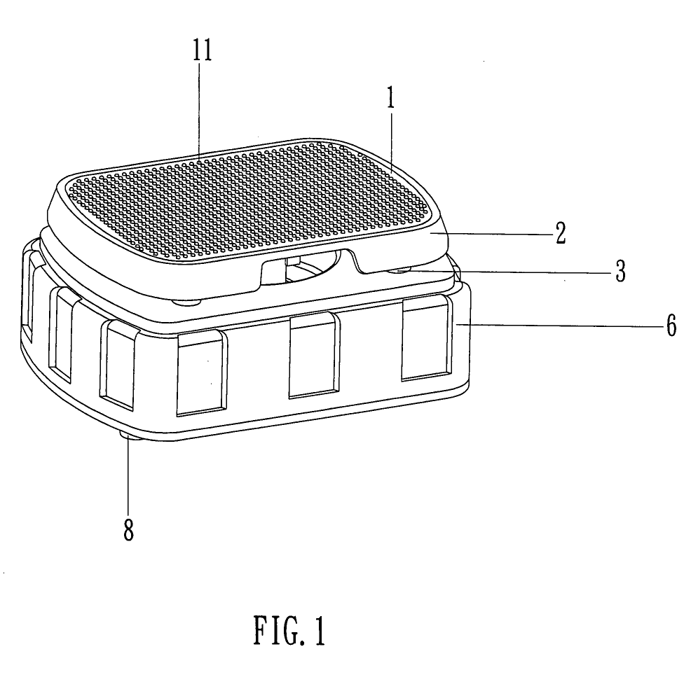

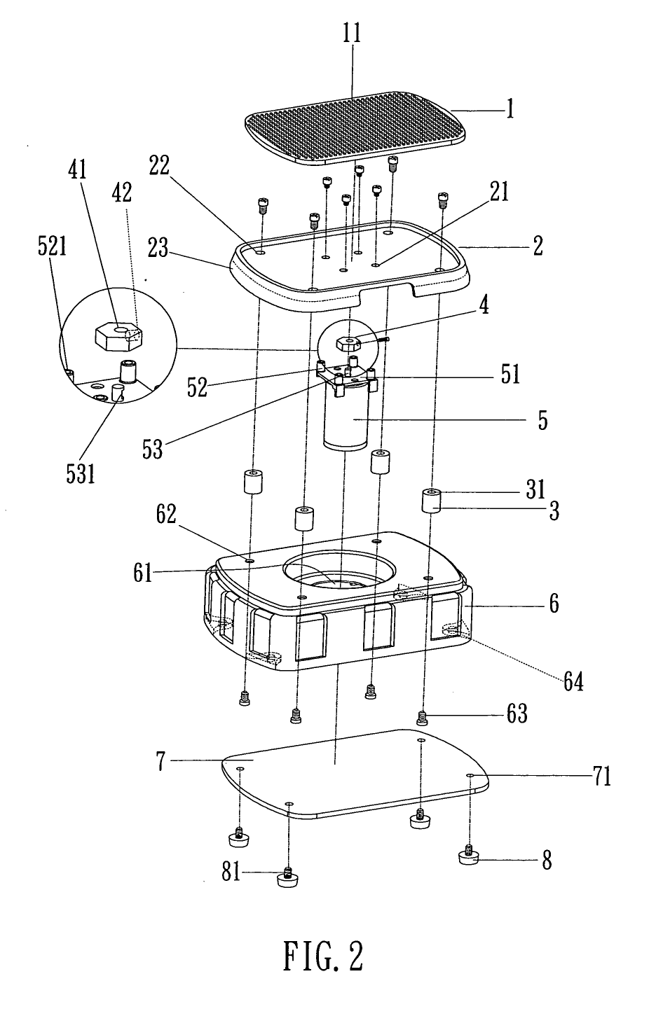

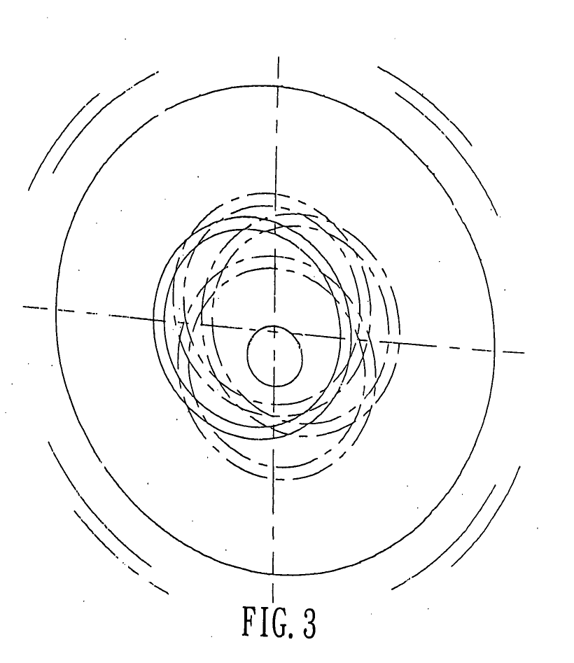

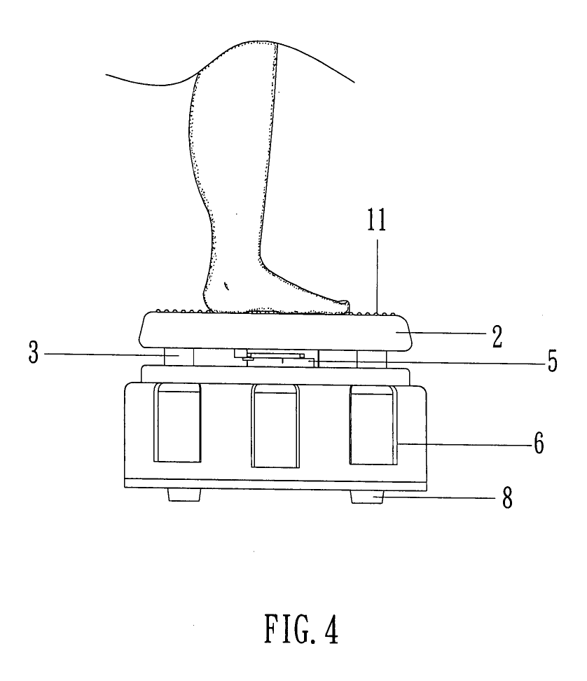

Referring to FIGS. 1 to 4, the foot massage device of the present invention comprises a base 6 which includes a hole 61 defined in a top thereof and four connection members 64 are fixed to an inner periphery of the sidewall of the base 6. A bottom board 7 is connected to an underside of the base 6 and a plurality of screws 81 extend through holes 71 in the bottom board 7 and are threadedly connected to the connection members 64. Each screw 81 is connected to an anti-slip members 8 so that the base 6 does not slip on floor. A plurality of flexible members 3 such as rubber tubes are connected on a top of the base 6 by extending bolts 63 through holes 62 defined through the top of the base 6 from the underside of the base 6 and are connected to a threaded passage 31 of the flexible members 3.

A motor 5 includes a top board 51 on a top thereof and a plurality of connection members 51 extend from the to board 51, each connection member 51 includes a threaded hole 521. An output shaft 53 extends through the top board 51 and includes a recess 531 defined radially in an outer periphery thereof. A weight member 4 has an eccentric hole 41 through which the output shaft 53 extends. A side hole 42 is defined in the weight member 4 and communicates with the eccentric hole 41. A bolt extends through the side hole 42 and a distal end of the bolt is engaged with the recess 531.

A top plate 2 includes a skirt portion 23 and its underside is connected to the flexible members 3 by extending bolts through holes 22 in the top plate 2 and engaged with the threaded passages 31 in the flexible members 3. The motor 5 is connected to the underside of the top plate 2 by extending bolts through holes 21 in the top plate 2 and connected to the threaded holes 521 of the connection members 51. The motor 5 is hanged on the top plate 2 and is inserted into the hole 61 of the base 6.

A pad 1 is connected on a top of the top plate 2 and includes a plurality of stimulation protrusions 11 on a top thereof so that the users' feet can be put on the pad 1 when in use.

When activating the motor 5, the weight member 4 is eccentrically rotated an the motor 5 together with the top plate 2 shake in horizontal direction and the flexible members 3 are deformed by the shaking force so that the top plate 2 together with the pad 1 are moved reciprocally. The users' feet are then stimulated and massaged.

While we have shown and described the embodiment in accordance with the present invention, it should be clear to those skilled in the art that further embodiments may be made without departing from the scope of the present invention.

What is claimed is:

1. A foot massage device comprising:
a base having a hole defined in a top thereof and a plurality of flexible members connected on a top of the base;
a motor having a top board on a top thereof and a plurality of connection members extending from the top board, an output shaft extending through the top board, a weight member eccentrically connected to the output shaft, and
a top plate having an underside connected to the flexible members and the motor connected to the underside of the top plate by the connection members, the motor being hanged within the hole of the base and swinging within the hole of the base when the weight member is rotated by the output shaft.

2. The device as claimed in claim 1, wherein a pad is connected on a top of the top plate and includes a plurality of stimulation protrusions.

3. The device as claimed in claim 1, wherein the output shaft includes a recess defined radially in an outer periphery thereof and the weight member has an eccentric hole through which the output shaft extends, a side hole defined in the weight member and communicates with the eccentric hole, a bolt extends through the side hole and a distal end of the bolt is engaged with the recess.
